(19) United States
(12) Patent Application Publication
(10) Pub. No.: US 2024/0030833 A1
(43) Pub. Date: Jan. 25, 2024

(54) INVERTER AND CONTROL METHOD FOR INVERTER

(71) Applicant: KABUSHIKI KAISHA TOYOTA JIDOSHOKKI, Kariya-shi (JP)

(72) Inventor: Yusuke SHINTANI, Kariya-shi (JP)

(73) Assignee: KABUSHIKI KAISHA TOYOTA JIDOSHOKKI, Kariya-shi (JP)

(21) Appl. No.: 18/349,310

(22) Filed: Jul. 10, 2023

(30) Foreign Application Priority Data
Jul. 22, 2022 (JP) 2022-117019

(51) Int. Cl. H02M 7/5387; H02M 1/084; H02M 1/32

(52) U.S. Cl. CPC H02M 7/53873; H02M 1/0845; H02M 1/325

(57) ABSTRACT

An inverter including two switching elements of an inverter circuit connected in series to each other, drivers configured to respectively drive switching elements, and protection circuits each configured to transmit an output signal of the driver to each of the switching elements via a first resistor element. The protection circuit includes a second resistor element arranged to be electrically connectable in parallel to a first resistor element and a switch configured to switch between a first state in which electrical parallel connection of the second resistor element to the first resistor element is enabled and a second state in which the connection is cancelled. The protection circuit is configured to determine whether a short-circuit current has been generated in a first pattern or a second pattern and switch the switch to the first state in a case of determining that the short-circuit current of the second pattern has been generated.

### BACKGROUND

### 1. Field

The present disclosure relates to an inverter and a control method for the inverter.

### 2. Description of Related Art

Japanese Laid-Open Patent Publication No. 2019-88084 discloses an inverter that includes switching elements of upper and lower arms, a soft cutoff resistor element, and a soft cutoff switching element. Each switching element includes a control terminal, and is turned on when a voltage is applied to the control terminal. The soft cutoff resistor element is connected to the control terminal of the switching element via the soft cutoff switching element. When a short-circuit fault occurs in one of the switching elements of the upper and lower arms, the other switching element needs to be protected. Hereinafter, a switching element in which a short-circuit fault occurs is referred to as a short-circuiting element, and a switching element that needs to be protected is referred to as a protected element. In the inverter disclosed in the above publication, when a short-circuit fault occurs, the soft cut-off resistor element can be connected to the control terminal of the protected element by turning on the soft cut-off switching element. This allows the protected element to be protected by reducing the voltage applied to the control terminal.

The generation pattern of the short-circuit current flowing through the protected element can be classified into two types depending on whether the protected element is off or on at a time when a short-circuit fault occurs in the short-circuiting element. One is a generation pattern in a case in which the protected element is off at a time when a short-circuit fault occurs in the short-circuiting element. In this case, when the protected element is turned on in a state in which a short-circuit fault has occurred, the short-circuit current flowing through the protected element gradually increases. The other one is a generation pattern in a case in which the protected element is on at a time when a short-circuit fault occurs in the short-circuiting element. In this case, when a short-circuit fault occurs in the short-circuiting element, the short-circuit current flowing through the protected element increases rapidly. The switching element needs to be properly protected in accordance with the generation pattern of the short-circuit current flowing through the protected element.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An inverter according to an aspect of the present disclosure includes two switching elements of an inverter circuit, the two switching elements being connected in series to each other, drivers configured to respectively drive the switching elements, and protection circuits each including a first resistor element, the protection circuit being configured to transmit an output signal of the driver to each of the switching elements via the first resistor element. One of the two switching elements in which a short-circuit fault occurs is a short-circuiting element and the other one of the two switching elements is a protected element. A generation pattern of a short-circuit current flowing through the protected element includes a first pattern in which a short-circuit current flows through the protected element in a case in which the protected element is turned on in a state in which a short-circuit fault has occurred in the short-circuiting element and a second pattern in which a short-circuit current flows through the protected element in a case in which a short-circuit fault occurs in the short-circuiting element in a state in which the protected element is on. The protection circuit includes a second resistor element arranged to be electrically connectable in parallel to the first resistor element and a switch configured to switch between a first state in which electrical parallel connection of the second resistor element to the first resistor element is enabled and a second state in which the electrical parallel connection of the second resistor element to the first resistor element is cancelled. The protection circuit is further configured to determine whether a short-circuit current of the first pattern or a short-circuit current of the second pattern has been generated and switch the switch to the first state in a case of determining that the short-circuit current of the second pattern has been generated.

An inverter according to another aspect of the present disclosure includes two switching elements of an inverter circuit, the two switching elements being connected in series to each other, drivers configured to respectively drive the switching elements, and protection circuits each including a first resistor element, the protection circuit being configured to transmit an output signal of the driver to each of the switching elements via the first resistor element. One of the two switching elements in which a short-circuit fault occurs is a short-circuiting element and the other one of the two switching elements is a protected element. A generation pattern of a short-circuit current flowing through the protected element includes a first pattern in which a short-circuit current flows through the protected element in a case in which the protected element is turned on in a state in which a short-circuit fault has occurred in the short-circuiting element and a second pattern in which a short-circuit current flows through the protected element in a case in which a short-circuit fault occurs in the short-circuiting element in a state in which the protected element is on. The protection circuit includes a second resistor element arranged to be electrically connectable in parallel to the first resistor element and a switch configured to switch between a first state in which electrical parallel connection of the second resistor element to the first resistor element is enabled and a second state in which the electrical parallel connection of the second resistor element to the first resistor element is cancelled. The protection circuit is further configured to determine whether a short-circuit current of the second pattern has been generated and switch the switch to the first state in a case of determining that the short-circuit current of the second pattern has been generated.

A further aspect of the present disclosure provides a control method for an inverter. The inverter includes two switching elements of an inverter circuit, the two switching elements being connected in series to each other, drivers configured to respectively drive the switching elements, and protection circuits each including a first resistor element, the protection circuit being configured to transmit an output signal of the driver to each of the switching elements via the first resistor element. One of the two switching elements in which a short-circuit fault occurs is a short-circuiting element and the other one of the two switching elements is a protected element. A generation pattern of a short-circuit current flowing through the protected element includes a first pattern in which a short-circuit current flows through the protected element in a case in which the protected element is turned on in a state in which a short-circuit fault has occurred in the short-circuiting element and a second pattern in which a short-circuit current flows through the protected element in a case in which a short-circuit fault occurs in the short-circuiting element in a state in which the protected element is on. The protection circuit includes a second resistor element arranged to be electrically connectable in parallel to the first resistor element and a switch configured to switch between a first state in which electrical parallel connection of the second resistor element to the first resistor element is enabled and a second state in which the electrical parallel connection of the second resistor element to the first resistor element is cancelled. The control method includes determining whether a short-circuit current of the second pattern has been generated and switching the switch to the first state in a case of determining that the short-circuit current of the second pattern has been generated.

Other features and aspects will be apparent from the following detailed description, the drawings, and the claims.

### BRIEF DESCRIPTION OF DRAWINGS

FIG. 1 is a schematic diagram showing the configuration of a motor drive device.

FIG. 2 is a schematic diagram showing the configuration of a driver and a protection circuit that are included in the inverter control device of the motor drive device shown in FIG. 1.

FIG. 3 is a graph showing the relationship between the time and the current flowing through the protected element when a short-circuit fault occurs in the short-circuiting element included in the inverter circuit of the motor drive device shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of an inverter will now be described.

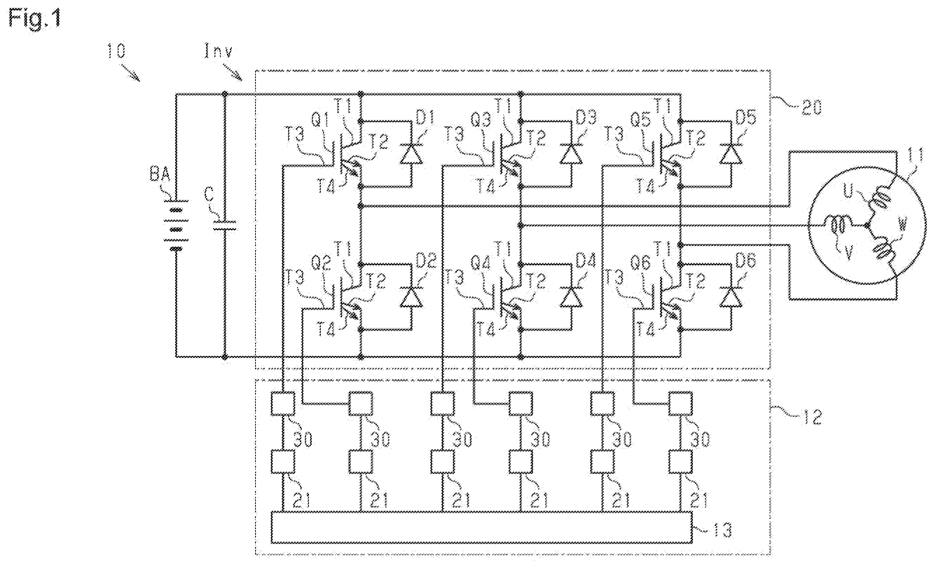

Referring to FIG. 1, a motor drive device 10 is used to drive a motor 11. The motor 11 is a three-phase AC motor including three-phase coils U, V, W. The motor 11 may be mounted on any device. The motor 11 is mounted on, for example, a motor-driven compressor, an industrial vehicle, or a passenger vehicle.

Motor Drive Device

The motor drive device 10 includes a battery BA, a smoothing capacitor C, and an inverter Inv. The inverter Inv includes an inverter circuit 20 and an inverter control device 12.

The inverter circuit 20 includes legs connected in parallel to each other. Each leg includes two switching elements connected in series to each other. In the example shown in the drawing, the inverter circuit 20 includes six switching elements Q1, Q2, Q3, Q4, Q5, Q6 and six diodes D1, D2, D3, D4, D5, D6. The switching elements Q1 to Q6 are, for example, insulated-gate bipolar transistors (IGBTs) or metal-oxide-semiconductor field-effect transistors (MOSFETs). The switching elements Q1 to Q6 each include a first terminal T1, a second terminal T2, a control terminal T3, and a sense terminal T4. If the switching elements Q1 to Q6 are IGBTs, the first terminals T1 are collectors, the second terminals T2 are emitters, and the control terminals T3 are gates. If the switching elements Q1 to Q6 are MOSFETs, the first terminals T1 are drains, the second terminals T2 are sources, and the control terminals T3 are gates.

The switching elements Q1, Q2 of the U-phase leg are connected in series to each other. The switching elements Q3, Q4 of the V-phase leg are connected in series to each other. The switching elements Q5, Q6 of the W-phase leg are connected in series to each other. The switching elements Q1, Q3, Q5 are included in the upper arm of the corresponding leg. The switching elements Q2, Q4, Q6 are included in the lower arm of the corresponding leg. The diodes Q1 to Q6 are connected in parallel to the switching elements D1 to D6, respectively.

The battery BA is connected to the switching elements Q1 to Q6 via the smoothing capacitor C. The inverter circuit 20 converts DC power input from the battery BA into AC power, and outputs the AC power to the motor 11. Thus, the motor 11 is driven. The rated voltage of the battery BA is, for example, 800 V.

A connection point between the switching elements Q1, Q2 is connected to a coil U. A connection point between the switching elements Q3, Q4 is connected to a coil V. A connection point between the switching elements Q5, Q6 is connected to a coil W.

The inverter control device 12 includes a controller 13, drivers 21, and protection circuits 30.

The controller 13 outputs a control signal to the driver 21. The controller 13 includes a processor and a memory. The processor is, for example, a central processing unit (CPU), a graphics processing unit (GPU), or a digital signal processor (DSP). The memory includes a random access memory (RAM) and a read-only memory (ROM). The memory stores program codes or instructions configured to cause the processor to execute processes. The memory, or a computer-readable medium, includes any type of media that is accessible by general-purpose computers or dedicated computers. The controller 13 may include a hardware circuit such as an application-specific integrated circuit (ASIC) or a field-programmable gate array (FPGA). The controller 13, which is processing circuitry, may include one or more processors that run according to a computer program, one or more hardware circuits (e.g., ASICs or FPGAs), or a combination thereof.

Each driver 21 is individually disposed for a corresponding one of the switching elements Q1 to Q6. The hardware configuration of the driver 21 may be the same as that of the controller 13, for example. In response to a control signal from the controller 13, the driver 21 executes a switching operation on the one of the switching elements Q1 to Q6 that corresponds to the driver 21.

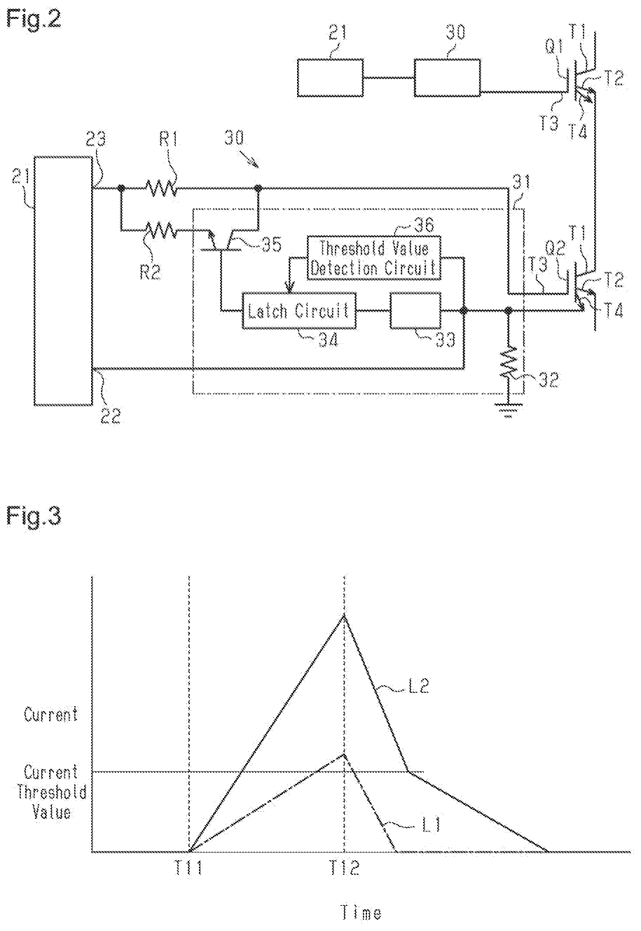

As shown in FIG. 2, the driver 21 includes a short-circuit detection terminal 22 and a protection terminal 23.

Protection Circuit

Each protection circuit 30 is individually disposed for a corresponding one of the switching elements Q1 to Q6. The hardware configuration of the protection circuit 30 may be the same as that of the controller 13, for example. The protection circuit 30 protects the one of the switching elements Q1 to Q6 that corresponds to the protection circuit 30. The protection circuit 30 is located between the driver 21 and the corresponding one of the switching elements Q1 to Q6. The protection circuit 30 includes a first resistor element R1, a second resistor element R2, and a switching circuit 31. The switching circuit 31 includes a shunt resistor element 32, a determination unit 33, a latch circuit 34, a switch 35, and a threshold value detection circuit 36.

The first resistor element R1 connects the control terminal T3 to the protection terminal 23. The first resistor element R1 is connected in series between the control terminal T3 and the protection terminal 23. The driver 21 transmits an output signal to the one of the switching elements Q1 to Q6 that corresponds to the driver 21 via the first resistor element R1.

The second resistor element R2 is arranged to be electrically connectable in parallel to the first resistor element R1. The resistance value [Ω] of the second resistor element R2 may be equal to or different from that of the first resistor element R1.

The shunt resistor element 32 is connected to the sense terminal T4. A minute current proportional to the current flowing between the first and second terminals T1 and T2 flows through the sense terminal T4. In the shunt resistor element 32, a voltage drop occurs in correspondence with the current flowing between the first and second terminals T1 and T2. The short-circuit detection terminal 22 of the driver 21 is connected to a connection point between the shunt resistor element 32 and the sense terminal T4.

Based on the amount of the voltage drop across the shunt resistor element 32, the driver 21 determines whether the current flowing through the one of the switching elements Q1 to Q6 that corresponds to the driver 21 is greater than or equal to a short-circuit detection threshold value. The short-circuit detection threshold value is determined in advance. The short-circuit detection threshold value is set to be higher than a value in a normal use current region. The current flowing through the switching elements Q1 to Q6 refers to the current flowing between the first terminals T1 and the second terminals T2 of the switching elements Q1 to Q6. When the current flowing through the one of the switching elements Q1 to Q6 that corresponds to the driver 21 is greater than or equal to the short-circuit detection threshold value, the driver 21 determines that a short-circuit fault has occurred in the one of the switching elements Q1 to Q6 that is connected in series to the corresponding one of the switching elements Q1 to Q6. For example, when detecting that the current flowing through the switching element Q2 is greater than or equal to the short-circuit detection threshold value, the driver 21 corresponding to the switching element Q2 determines that a short-circuit fault has occurred in the switching element Q1.

The one of the switching elements Q1 to Q6 in which a short-circuit fault occurs is referred to as a short-circuiting element, and the one of the switching elements Q1 to Q6 that is connected in series to the short-circuiting element is referred to as a protected element. The determination unit 33 is used to determine the type of the generation pattern of a short-circuit current flowing through the protected element when a short-circuit fault occurs in the short-circuiting element. The hardware configuration of the determination unit 33 may be the same as that of the controller 13, for example. In a first pattern, a short-circuit current flows through the protected element when the protected element is turned on in a state in which a short-circuit fault has occurred in the short-circuiting element. In a second pattern, a short-circuit current flows through the protected element when a short-circuit fault occurs in the short-circuiting element in a state in which the protected element is on. The short-circuit current of the first pattern is generated when the switching elements Q1 to Q6 of one of the upper and lower arms are turned on in a state in which a short-circuit has occurred in the switching elements Q1 to Q6 of the other arm. The short-circuit current of the second pattern is generated when a short-circuit occurs in the switching elements Q1 to Q6 of one of the upper and lower arms in a state in which the switching elements Q1 to Q6 of the other arm are on.

FIG. 3 shows a case in which a short-circuit fault occurs in the short-circuiting element at time T11. As indicated by line L1, in the first pattern, when the protected element is turned on in a state in which a short-circuit fault has occurred in the short-circuiting element, the short-circuit current flowing through the protected element gradually increases. As indicated by line L2, in the second pattern, when a short-circuit fault occurs in the short-circuiting element with the protected element on, a short-circuit occurs in the leg including the short-circuiting element. As a result, the short-circuit current flowing through the protected element rapidly increases.

As shown in FIG. 2, the determination unit 33 is connected to a connection point between the sense terminal T4 and the shunt resistor element 32. Based on a voltage drop amount in the shunt resistor element 32, the determination unit 33 determines whether an increase amount per unit time in the current flowing through the switching elements Q1 to Q6 is greater than or equal to a first threshold value and less than a second threshold value. Based on the voltage drop amount in the shunt resistor element 32, the determination unit 33 determines whether the increase amount per unit time in the current flowing through the switching elements Q1 to Q6 is greater than or equal to the second threshold value. The increase amount per unit time in the current flowing through the switching elements Q1 to Q6 is represented by the slope of current in a case in which the vertical axis represents current and the horizontal axis represents time.

The first threshold value is set to determine whether the short-circuit current of the first pattern has been generated. When the short-circuit current of the first pattern is generated, the increase amount per unit time in the current flowing through the protected element is larger than that in a case in which no short-circuit fault has occurred in the short-circuiting element. This allows the determination unit 33 to determine that the short-circuit current of the first pattern has been generated by setting the first threshold value to be higher than the increase amount per unit time in the current flowing through the protected element when no short-circuit fault occurs. Specifically, when the increase amount per unit time in the current flowing through the switching elements Q1 to Q6 is greater than or equal to the first threshold value and less than the second threshold value, the determination unit 33 determines that the short-circuit current of the first pattern has been generated; that is, the short-circuit current of the first pattern has flowed through the protected element.

The second threshold value is larger than the first threshold value. The second threshold value is set to determine whether the short-circuit current of the second pattern has been generated. The increase amount per unit time in the current is larger when the short-circuit current of the second pattern is generated than when the short-circuit current of the first pattern is generated. This allows the determination unit 33 to determine that the short-circuit current of the second pattern has been generated by setting the second threshold value to be higher than the increase amount per unit time in the current when the short-circuit current of the first pattern is generated. When the increase amount per unit time in the current flowing through the switching elements Q1 to Q6 is greater than or equal to the second threshold value, the determination unit 33 determines that the short-circuit current of the second pattern has been generated; that is, the short-circuit current of the second pattern has flowed through the protected element. When the short-circuit current of the second pattern is generated, the determination unit 33 turns on the switch 35. For example, when the short-circuit current of the second pattern flows through the protected element, the determination unit 33 turns on the switch 35 by outputting a high-level signal to the latch circuit 34.

When the switch 35 is turned on by the determination unit 33, the latch circuit 34 keeps the switch 35 on.

The switch 35 is connected in series to the second resistor element R2. The switch 35 and the second resistor element R2 are connected in parallel to the first resistor element R1. When the switch 35 is on, the second resistor element R2 is electrically connected in parallel to the first resistor element R1. When the switch 35 is off, the electrical parallel connection of the second resistor element R2 to the first resistor element R1 is cancelled. The switch 35 is a switching element, such as a transistor. The switch 35 is configured to switch between a first state in which the electrical parallel connection of the second resistor element R2 to the first resistor element R1 is enabled and a second state in which the electrical parallel connection of the second resistor element R2 to the first resistor element R1 is cancelled.

The threshold value detection circuit 36 is connected to a connection point between the sense terminal T4 and the shunt resistor element 32. The threshold value detection circuit 36 is connected between the sense terminal T4 and the shunt resistor element 32. Based on the voltage drop amount in the shunt resistor element 32, the threshold value detection circuit 36 determines whether the current flowing through the switching elements Q1 to Q6 is less than a current threshold value. The hardware configuration of the threshold value detection circuit 36 may be the same as that of the controller 13, for example. When the current flowing through the switching elements Q1 to Q6 becomes less than the current threshold value, the threshold value detection circuit 36 turns off the switch 35 by controlling the latch circuit 34. The current threshold value is determined in advance.

### Operation of Present Embodiment

The operation of the protection circuit 30 will now be described with an example in which a short-circuit fault has occurred in the switching element Q1 of the upper arm in the switching elements Q1, Q2. In a case in which a short-circuit fault has occurred in the switching element Q2 of the lower arm, the protection circuit 30 operates in the same manner. The protection circuits 30 in the switching elements Q3, Q4, Q5, Q6 function in the same manner.

When the short-circuit current of the first pattern is generated, the determination unit 33 does not turn on the switch 35. Thus, only the first resistor element R1 of the first resistor element R1 and the second resistor element R2 is electrically connected to the control terminal T3 of the switching element Q2.

When the current flowing through the switching element Q2 is greater than or equal to the short-circuit detection threshold value, the driver 21 turns off the switching element Q2 by reducing the voltage applied to the control terminal T3. The voltage applied to the control terminal T3 is reduced by the charge stored in the control terminal T3 flowing toward the protection terminal 23. When the short-circuit current of the first pattern is generated, the charge of the control terminal T3 flows toward the protection terminal 23 via the first resistor element R1. As shown in FIG. 3, when the voltage applied to the control terminal T3 starts to decrease at time T12, the current flowing through the switching element Q2 decreases as the switching element Q2 approaches an off state. When the switching element Q2 is turned off, the switching element Q2 is protected from overcurrent.

When the short-circuit current of the second pattern is generated, the determination unit 33 turns on the switch 35. This electrically connects the control terminal T3 of the switching element Q2 to the first resistor element R1 and the second resistor element R2 that are electrically connected in parallel to each other.

When the current flowing through the switching element Q2 is greater than or equal to the short-circuit detection threshold value, the driver 21 turns off the switching element Q2 by reducing the voltage applied to the control terminal T3. When the short-circuit current of the second pattern is generated, the charge of the control terminal T3 flows toward the protection terminal 23 via the first resistor element R1 and the second resistor element R2. The resistance value of a combined resistor of the first resistor element R1 and the second resistor element R2 is smaller than the resistance value of the first resistor element R1. Thus, the voltage applied to the control terminal T3 can be reduced more easily than when only the first resistor element R1 is connected to the control terminal T3.

If the short-circuit current of the second pattern is generated and the voltage applied to the control terminal T3 starts to decrease at time T12, the voltage applied to the control terminal T3 decreases during a short period of time. This causes the switching element Q2 to be abruptly turned off. When the switching element Q2 is abruptly turned off, the switching element Q2 may be damaged by a surge. For this reason, when the current flowing through the switching element Q2 becomes less than the current threshold value, the threshold value detection circuit 36 turns off the switch 35. Since only the first resistor element R1 is electrically connected to the control terminal T3, the voltage applied to the control terminal T3 is less likely to decrease. That is, the charge of the control terminal T3 is less likely to flow toward the protection terminal 23. This prevents the switching element Q2 from being abruptly turned off. The current threshold value is set such that the switching element Q2 is not damaged by a surge.

### Advantages of Present Embodiment

(1) When a short-circuit fault occurs, the protection circuit 30 lowers the voltage applied to the control terminal T3 to turn off the corresponding one of the switching elements Q1 to Q6. Thus, the protection circuit 30 protects the corresponding one of the switching elements Q1 to Q6. The resistance value of the combined resistor in which the first resistor element R1 and the second resistor element R2 are electrically connected in parallel to each other is lower than the resistance value of the first resistor element R1 alone. As the resistance value of a resistor element connected to the control terminal T3 decreases, the voltage applied to the control terminal T3 can be reduced more easily. By switching whether to enable the electrical parallel connection of the second resistor element R2 to the first resistor element R1 in accordance with the generation pattern of the short-circuit current, the corresponding one of the switching elements Q1 to Q6 is protected in accordance with the generation pattern of the short-circuit current.
(2) The determination unit 33 determines that the short-circuit current of the second pattern has been generated when the increase amount per unit time in the current flowing through the corresponding one of the switching elements Q1 to Q6 is greater than or equal to the second threshold value. This allows the determination unit 33 to properly determine that the short-circuit current of the second pattern has been generated and thus allows the second resistor element R2 to be electrically connected in parallel to the first resistor element R1.
(3) The threshold value detection circuit 36 switches the switch 35 to the second state so as to enter a state in which the second resistor element R2 is not electrically connected in parallel to the first resistor element R1 when the current flowing through the corresponding one of the switching elements Q1 to Q6 is less than the current threshold value. Thus, when the short-circuit current of the second pattern is generated, the switching element Q2 is prevented from being abruptly turned off. This prevents the switching element Q2 from being damaged by a surge.
(4) In the present embodiment, it is determined whether the generation pattern of the short-circuit current is the first or second pattern. Thus, the switching elements Q1 to Q6 are protected using a different method in accordance with the generation pattern of the short-circuit current. Specifically, when the generation pattern of the short-circuit current is the first pattern, only the first resistor element R1 is used to reduce the voltage applied to the control terminal T3. When the generation pattern of the short-circuit current is the second pattern, the voltage applied to the control terminal T3 is reduced using the first resistor element R1 and the second resistor element R2.

Regardless of whether the generation pattern of the short-circuit current is the first or second pattern, the switching elements Q1 to Q6 may be protected using the same method. For example, regardless of whether the generation pattern of the short-circuit current is the first or second pattern, the corresponding one of the switching elements Q1 to Q6 may be turned off using only the first resistor element R1. In this case, the protection of the corresponding one of the switching elements Q1 to Q6 from the short-circuit current of the second pattern requires a reduction of the short-circuit detection threshold value. In this case, it may be determined that a short-circuit current flows through the protected element even in the normal use current region. Thus, it may be determined that a short-circuit current is generated even if no short-circuit current is generated. Further, if the switching elements Q1 to Q6 are also protected from the short-circuit current of the first pattern using a method suitable for the short-circuit current of the second pattern, the switching elements Q1 to Q6 may be damaged by the short-circuit current of the first pattern. Thus, regardless of whether the generation pattern of the short-circuit current is the first or second pattern, it is difficult to protect the switching elements Q1 to Q6 using the same method. In the present embodiment, the switching elements Q1 to Q6 are protected using a different method in accordance with the generation pattern of the short-circuit current flowing through the protected element. Hence, the switching elements Q1 to Q6 are properly protected in accordance with the generation pattern of the short-circuit current.

### Modifications

The present embodiment may be modified as follows. The present embodiment and the following modifications can be combined as long as the combined modifications remain technically consistent with each other.

The switching circuit 31 does not have to include the threshold value detection circuit 36. In this case, when the generation pattern of the short-circuit current flowing through the protected element is the second pattern, the switch 35 does not have to be switched to the second state so as to enter a state in which the second resistor element R2 is not electrically connected in parallel to the first resistor element R1 in correspondence with the current flowing through the corresponding one of the switching elements Q1 to Q6.

The switching circuit 31 may be incorporated in the driver 21.

The first resistor element R1 may include resistor elements. Likewise, the second resistor element R2 may include resistor elements.

The determination unit 33 only needs to be able to determine whether the generation pattern of a short-circuit current is the second pattern, and does not have to be able to determine whether the generation pattern of a short-circuit current is the first pattern. For example, the determination unit 33 determines that the generation pattern of a short-circuit current is the second pattern when the increase amount per unit time in the current flowing through the corresponding one of the switching elements Q1 to Q6 is greater than or equal to the second threshold value. The determination unit 33 does not have to determine whether the increase amount per unit time in the current flowing through the corresponding one of the switching elements Q1 to Q6 is greater than or equal to the first threshold value. When the short-circuit current of the second pattern is generated, the determination unit 33 turns on the switch 35. When the generation pattern of the short-circuit current is the second pattern, the determination unit 33 turns on the switch 35. Thus, the same advantage as that of the embodiment is obtained even when it is not determined whether the generation pattern of the short-circuit current is the first pattern.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An inverter, comprising:
two switching elements of an inverter circuit, the two switching elements being connected in series to each other;
drivers configured to respectively drive the switching elements; and
protection circuits each including a first resistor element, the protection circuit being configured to transmit an output signal of the driver to each of the switching elements via the first resistor element, wherein
one of the two switching elements in which a short-circuit fault occurs is a short-circuiting element and the other one of the two switching elements is a protected element,
a generation pattern of a short-circuit current flowing through the protected element includes:
a first pattern in which a short-circuit current flows through the protected element in a case in which the protected element is turned on in a state in which a short-circuit fault has occurred in the short-circuiting element; and
a second pattern in which a short-circuit current flows through the protected element in a case in which a short-circuit fault occurs in the short-circuiting element in a state in which the protected element is on,
the protection circuit includes:
a second resistor element arranged to be electrically connectable in parallel to the first resistor element; and
a switch configured to switch between a first state in which electrical parallel connection of the second resistor element to the first resistor element is enabled and a second state in which the electrical parallel connection of the second resistor element to the first resistor element is cancelled, and
the protection circuit is further configured to:
determine whether a short-circuit current of the first pattern or a short-circuit current of the second pattern has been generated; and
switch the switch to the first state in a case of determining that the short-circuit current of the second pattern has been generated.

2. The inverter according to claim 1, wherein the protection circuit is configured to:
determine that the short-circuit current of the first pattern has been generated in a case in which an increase amount per unit time in the current flowing through the switching elements is greater than or equal to a first threshold value and less than a second threshold value, the second threshold value being greater than the first threshold value; and
determine that the short-circuit current of the second pattern has been generated in a case in which the increase amount per unit time in the current flowing through the switching elements is greater than or equal to the second threshold value.

3. The inverter according to claim 1, wherein the protection circuit is configured to switch the switch to the second state in a case in which the current flowing through the switching elements is less than a current threshold value.

4. The inverter according to claim 1, wherein the protection circuit is configured to switch the switch to the second state in a case of determining that the short-circuit current of the first pattern has been generated.

5. An inverter, comprising:
two switching elements of an inverter circuit, the two switching elements being connected in series to each other;
drivers configured to respectively drive the switching elements; and
protection circuits each including a first resistor element, the protection circuit being configured to transmit an output signal of the driver to each of the switching elements via the first resistor element, wherein
one of the two switching elements in which a short-circuit fault occurs is a short-circuiting element and the other one of the two switching elements is a protected element,
a generation pattern of a short-circuit current flowing through the protected element includes:
a first pattern in which a short-circuit current flows through the protected element in a case in which the protected element is turned on in a state in which a short-circuit fault has occurred in the short-circuiting element; and
a second pattern in which a short-circuit current flows through the protected element in a case in which a short-circuit fault occurs in the short-circuiting element in a state in which the protected element is on,
the protection circuit includes:
a second resistor element arranged to be electrically connectable in parallel to the first resistor element; and
a switch configured to switch between a first state in which electrical parallel connection of the second resistor element to the first resistor element is enabled and a second state in which the electrical parallel connection of the second resistor element to the first resistor element is cancelled, and
the protection circuit is further configured to:
determine whether a short-circuit current of the second pattern has been generated; and
switch the switch to the first state in a case of determining that the short-circuit current of the second pattern has been generated.

6. A control method for an inverter, wherein the inverter includes:
two switching elements of an inverter circuit, the two switching elements being connected in series to each other;
drivers configured to respectively drive the switching elements; and
protection circuits each including a first resistor element, the protection circuit being configured to transmit an output signal of the driver to each of the switching elements via the first resistor element,
one of the two switching elements in which a short-circuit fault occurs is a short-circuiting element and the other one of the two switching elements is a protected element,
a generation pattern of a short-circuit current flowing through the protected element includes:
a first pattern in which a short-circuit current flows through the protected element in a case in which the protected element is turned on in a state in which a short-circuit fault has occurred in the short-circuiting element; and
a second pattern in which a short-circuit current flows through the protected element in a case in which a short-circuit fault occurs in the short-circuiting element in a state in which the protected element is on,
the protection circuit includes:
a second resistor element arranged to be electrically connectable in parallel to the first resistor element; and
a switch configured to switch between a first state in which electrical parallel connection of the second resistor element to the first resistor element is enabled and a second state in which the electrical parallel connection of the second resistor element to the first resistor element is cancelled, and
the control method comprising:
determining whether a short-circuit current of the second pattern has been generated; and
switching the switch to the first state in a case of determining that the short-circuit current of the second pattern has been generated.
